(19) United States
(12) Patent Application Publication
(10) Pub. No.: US 2013/0306552 A1
(43) Pub. Date: Nov. 21, 2013

(54) METHOD OF FORMING FILTER ELEMENTS

(71) Applicants: Satishkumar Chamyvelumani, Chennai (IN); Richard A. Kirchner, St. Paul, MN (US); Thomas J. Hamlin, Vernon, CT (US); William J. Feil, III, Woodbury, MN (US); Keith D. Solomon, Cheshire, CT (US)

(72) Inventors: Satishkumar Chamyvelumani, Chennai (IN); Richard A. Kirchner, St. Paul, MN (US); Thomas J. Hamlin, Vernon, CT (US); William J. Feil, III, Woodbury, MN (US); Keith D. Solomon, Cheshire, CT (US)

(73) Assignee: 3M INNOVATIVE PROPERTIES COMPANY, St. Paul, MN (US)

(21) Appl. No.: 13/880,942

(22) PCT Filed: Nov. 2, 2011
(86) PCT No.: PCT/US2011/058922

§ 371 Date: Jul. 31, 2013

Related U.S. Application Data
(60) Provisional application No. 61/410,222, filed on Nov. 4, 2010.

(51) Int. Cl. B29C 39/38; B01D 39/16

(52) U.S. Cl. CPC B29C 39/38; B01D 39/1661
USPC 210/504; 264/460; 249/78

(57) ABSTRACT

A method of forming a filter element is disclosed comprising introducing a mixture into a mold, the mixture comprising a plurality of susceptor particles and a plurality of polymeric binder particles. Eddy currents are induced in the susceptor particles by subjecting the mixture to a high-frequency electromagnetic field, the eddy currents being sufficient to elevate the temperature of the susceptor particles to cause adjacent polymeric binder particles to be heated to at least a softening point. The susceptor particles bind with the heated polymeric binder particles in the mold to form a coherent mass. The coherent mass is cooled to form the filter element.

### BACKGROUND

It has been known in the fluid filtration field to pass fluids through beds of particulate matter to assist in filtering or separating impurities from the fluid. These particulate beds, which often include adsorbent materials such as activated carbon, may be loose and granular or may be formed into a solid porous block. In either case, a fluid passing through the particulate bed may contact the surfaces of many adsorbent particles where impurities may be attracted and removed. At the same time, particulate impurities in the fluid may be removed by mechanical separation within the pore structure of the particulate bed. One increasingly common application for solid porous blocks is the growing field of drinking water purification. As potential applications for fluid filtration and separation grow and multiply, there is an ongoing need for improved processes and apparatuses for manufacturing solid porous blocks.

### SUMMARY OF THE INVENTION

The present disclosure relates to a method of forming a filter element comprising introducing a mixture into an apparatus comprising a mold, the mixture comprising a plurality of susceptor particles and a plurality of polymeric binder particles, inducing eddy currents in the susceptor particles by subjecting the mixture to a high-frequency electromagnetic field, the eddy currents being sufficient to elevate the temperature of the susceptor particles to cause adjacent polymeric binder particles to be heated to at least a softening point, binding the susceptor particles with the heated polymeric binder particles in the mold to form a coherent mass, and cooling the coherent mass to form the filter element.

In the above embodiment, the method may further comprise removing the coherent mass from the mold.

In the above embodiments, the mold may comprise a dielectric material.

In the above embodiments, the mold may comprise a porous sleeve into which the mixture is introduced such that the mold together with the coherent mass forms the filter element, the method comprising removing the mold from the apparatus together with the coherent mass.

In the above embodiments, the method may further comprise binding the coherent mass to the porous sleeve.

In the above embodiments, the porous sleeve may comprise a nonwoven sleeve coaxially surrounded by an outer sleeve comprising one of a porous polymer or a porous ceramic.

In the above embodiments, the method may further comprise placing the mold on a holder prior to introducing the mixture into the mold, and removing the mold from the holder after forming the coherent mass.

In the above embodiments, the holder may comprise a core pin, the core pin forming an internal profile of the coherent mass such that the coherent mass is tubular. In some such embodiments, the core pin comprises a dielectric material.

In the above embodiments, the mold may comprise a core pin, the core pin forming an internal profile of the coherent mass such that at least a portion of the coherent mass is tubular. In some such embodiments, the core pin comprises a dielectric material.

In the above embodiments, the high-frequency electromagnetic field may oscillate in a range from about 500 kHz to about 30 MHz.

In the above embodiments, the susceptor particles may comprise activated carbon.

In the above embodiments, the polymeric binder particles may comprise ultra high molecular weight polyethylene.

In the above embodiments, binding the susceptor particles with the heated polymeric binder particles may comprise sintering the mixture such that a coherent mass is formed but polymeric binder does not coat the susceptor particles.

In the above embodiments, the excitation portion may comprise an induction coil to generate the high frequency electromagnetic field, the method comprising moving the induction coil relative to the mold to subject the entire mixture to the high frequency electromagnetic field. In some such embodiments, the induction coil moves and the mold is fixed. In other embodiments, the mold moves and the induction coil is fixed.

In the above embodiments, the method may further comprise forming a plurality of depressions in an external profile of the filter element.

The present disclosure further relates to a filter element formed by the method of any of the above embodiments.

The present disclosure further relates to an apparatus for forming a filter element, the apparatus comprising a mold and an induction coil surrounding at least a portion of the mold to subject a mixture within the mold to a high frequency electromagnetic field, wherein the induction coil and the mold move with respect to one another to subject the entire mixture to the high frequency electromagnetic field. In some such embodiments, the induction coil moves and the mold is fixed. In other embodiments, the mold moves and the induction coil is fixed.

In the above embodiment, the mold may comprise a core pin, the core pin forming an internal profile of the filter element such that at least a portion of the filter element is tubular. In some such embodiments, the core pin comprises a dielectric material.

In the above embodiments, the high-frequency electromagnetic field may oscillate in a range from about 500 kHz to about 30 MHz.

The present disclosure further relates to an apparatus for forming a filter element, the apparatus comprising a holder to releasably hold a porous sleeve and an induction coil adjacent the holder to surround at least a portion of the porous sleeve to subject a mixture within the porous sleeve to a high frequency electromagnetic field.

In the above embodiment, the holder may comprise a mandrel upon which the porous sleeve is to be disposed.

In the above embodiments, the apparatus may further comprise a porous sleeve releasably held on the holder. In some such embodiments, in the porous sleeve comprises a nonwoven sleeve coaxially surrounded by an outer sleeve comprising one of a porous polymer or a porous ceramic.

In the above embodiments, the induction coil and the holder may move with respect to one another to subject the entire mixture to the high frequency electromagnetic field. In some such embodiments, the induction coil moves and the mold is fixed. In other embodiments, the mold moves and the induction coil is fixed.

In the above embodiments, the holder may comprise a core pin, the core pin forming an internal profile of the filter element such that at least a portion of the filter element is tubular, wherein the induction coil surrounds at least a portion of the core pin. In some such embodiments, the core pin comprises a dielectric material.

In the above embodiments, the high-frequency electromagnetic field may oscillate in a range from about 500 kHz to about 30 MHz.

In the above embodiments, the mold may comprise a plurality of forming protrusions extend inwardly from an inner surface of the mold.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIGS. 1-4 are schematic views of an apparatus for forming filter elements according to the present disclosure;

FIG. 5 is a schematic view of induction heating of a susceptor particle according to the present disclosure;

FIG. 6 is a schematic view of induction heating of a mixture according to the present disclosure;

FIG. 7a is a detailed schematic view of induction heating of a mixture according to the present disclosure;

FIG. 7b is a detailed schematic view of binding of a susceptor particle with a polymeric binder particle according to the present disclosure;

FIGS. 8 and 9 are perspective views of filter elements formed according to the present disclosure; and

FIG. 10 is a top view of a mold according to the present disclosure.

### DETAILED DESCRIPTION OF THE DRAWINGS

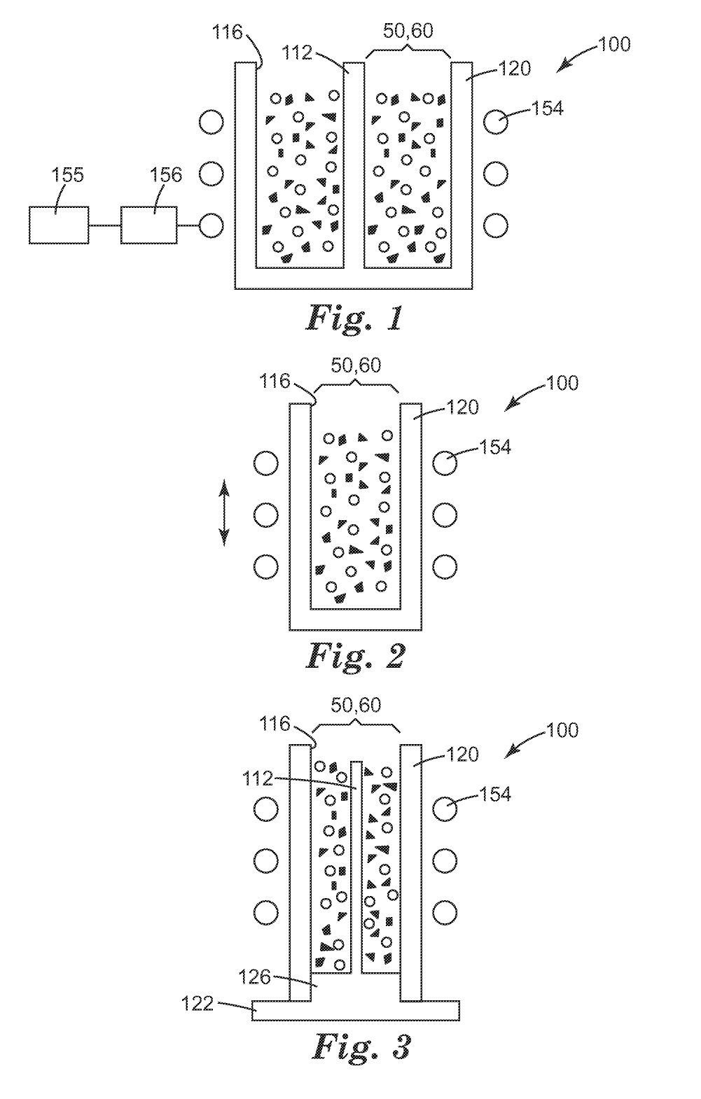

The present disclosure provides methods and apparatus 100 for forming filter elements 80, as depicted in FIGS. 8 and 9, from a mixture 50 comprising susceptor particles 52 and polymeric binder particles 56. Exemplary apparatuses 100 are depicted in FIGS. 1-4. The mixture 50, which may be pre-blended, is typically introduced into a mold 120. While the mixture 50 is in the mold 120, a high frequency electromagnetic field 152 is applied to the mixture 50. The high frequency electromagnetic field 152 generates eddy currents in the susceptor particles 52. The flow of eddy currents generates sufficient heat in the susceptor particles 52 to raise the temperature of adjacent polymeric binder particles 56 to at least a softening point. The heated susceptor particles 52 then bind with adjacent polymeric binder particles 56 such that the mixture 50 forms a coherent mass 60. The coherent mass 60 is then cooled to form the filter element 80. Mixtures 50 and filter elements 80 formed according to the present disclosure may include, but are not limited to, mixtures 50, filter elements 80, and media as shown and described in U.S. Pat. Nos. 7,112,280; 7,112,272; and 7,169,304 to Hughes et al., the disclosures of which are hereby incorporated by reference in their entirety.

The presently disclosed process can provide faster heating as compared to, for example, conductive heating methods, where heat originating from a barrel or jacket surrounding a mixture must be conducted across the entire cross section of the mixture 50 before the mixture can completely bind. Such reliance on conduction from a barrel or jacket typically requires relatively long exposure time to a heating section in order to provide sufficient time to fully heat the mixture. Longer heating times can be disadvantageous because they typically results in less efficient, and therefore more costly, production.

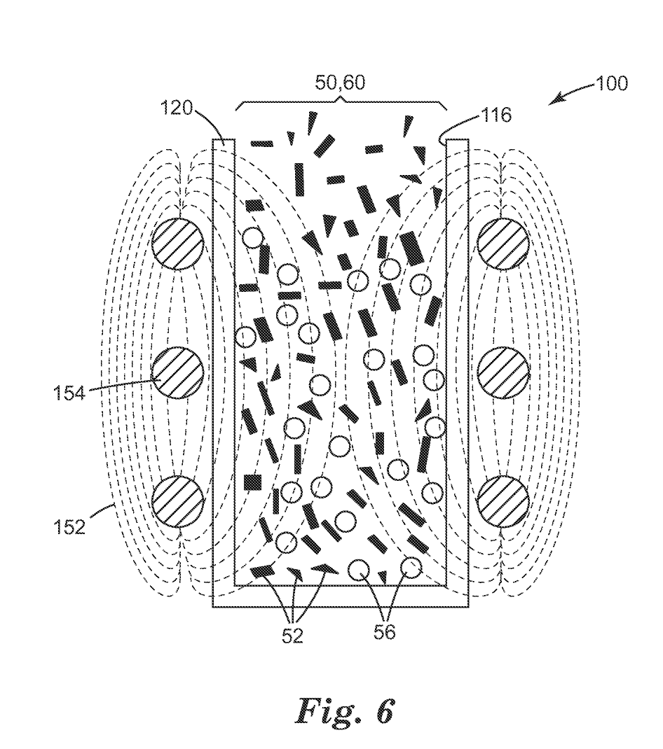

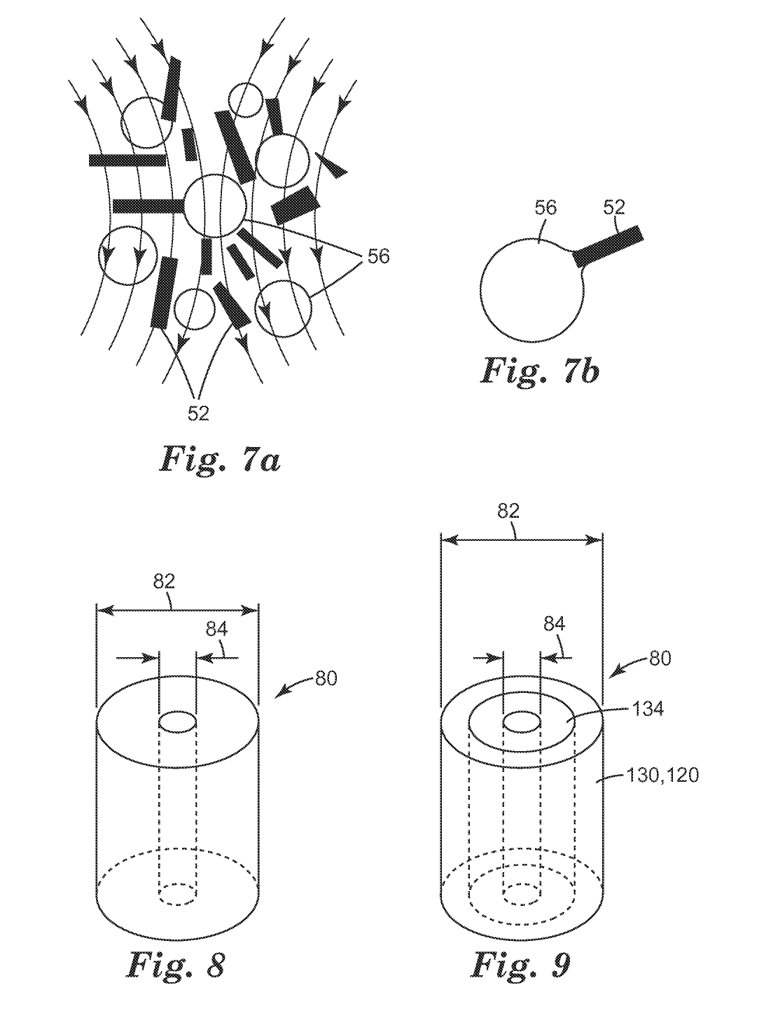

Representations of the process occurring in the mold 120 are depicted, for example, in FIGS. 6, 7a, and 7b. In a typical embodiment, the mixture 50 may enter the mold 120 at room temperature. Once in the mold 120, the mixture 50 of susceptor particles 52 and polymeric binder particles 56 is subjected to a high frequency electromagnetic field 152 to induce eddy currents in the susceptor particles 52. Because the susceptor particles 52 have an inherent electrical resistance, the currents induced in them generate energy that heats the susceptor particles 52.

It should be noted that, although the generation of eddy currents in the susceptor particles 52 is believed to dominate the presently disclosed heating process in the mold 120, some direct heating of the polymeric binder particles 56 may also occur through a process known as dielectric heating. Dielectric heating is a process by which heat is generated in dielectric or electrically insulating materials under the influence of a high frequency electromagnetic field 152. Unlike the generation of eddy currents in electrically conductive materials, however, dielectric heating results from the flipping of electrical dipole moments in the dielectrics they try to align themselves with the alternating electromagnetic field.

Because the mixture 50 is sufficiently compacted in the mold 120, the susceptor particles 52 tend to be in physical contact with one or more neighboring polymeric binder particles 56. The heat generated in the susceptor particles 52 is sufficient to cause conductive heating of neighboring polymeric binder particles 56 at the points of physical contact. This conductive heating is in turn sufficient to cause the polymeric binder particles 56 to be heated to at least a softening point to cause binding with the contacting susceptor particles 52. Such binding may take many forms depending on the chosen materials and desired application. One example of such binding is schematically represented in FIG. 7b.

In one embodiment, the high frequency electromagnetic field 152 in the mold 120 is generated by an induction coil 154 surrounding the mold 120. Typically, the induction coil 154 comprises a circular wound coil and the mold 120 comprises a hollow cylinder, the induction coil 154 encircling the mold 120 for a set number of turns. The number of turns may be, for example, 2, 3, 4, 5, 6, or more depending on the length of the heating mold 120 and the desired field. It is also envisioned that the induction coil 154 may comprise a more complex surrounding shape that does not strictly encircle the heating mold 120. For example, where other structures may interfere with an encircling induction coil 154, complex bends may be provided in the coil to avoid the interfering structure while still providing a high frequency electromagnetic field 152 suitable for heating the mixture 50 as presently disclosed.

Typically, the induction coil 154 is driven by a high frequency power supply 155 capable of setting up a high frequency alternating current in the coil—typically in a range from about 500 kHz to about 30 MHz., including about 1 MHz, 2 MHz, 4 MHz, 6 MHz, 8 MHz, 10 MHz, 12 MHz, 14 MHz, 16 MHz, 18 MHz, 20 MHz and all frequencies and ranges of frequencies between. Higher frequencies are also envisioned, provided eddy currents can be effectively induced in the susceptor particles 52 such that sufficient heating occurs.

The power used by the induction coil 154 may vary depending on, for example, the dimensions of the mold 120, the cross-sectional dimensions of the mixture 50 in the mold 120, the contents of the mixture 50, and the desired speed of heating. In one embodiment, the induction coil 154 may use an amount of power in a range from about 700 Watts to about 2000 Watts during the process, although higher power levels are envisioned depending on, for example, the desired overall heating speed.

In some embodiments, particularly where a relatively long aspect ratio coherent mass 60 is desired (e.g., a relatively small profile to length ratio), the induction coil 154 may not be of sufficient size, or be capable of generating a sufficient field, to heat the entire mold 120 at once. In such cases, the mold 120, the induction coil 154, or both, may be movable with respect to one another, as schematically shown in FIG. 2. For example, the mold 120 and the induction coil 154 may translate coaxially relative to one another to ensure that the high frequency electromagnetic field 152 sufficiently penetrates all portions of the mixture 50. Such a system may be useful where, for example, long coherent masses are desired such that each may be cut to length to form more than one filter element 80. In such cases, it may not be feasible to provide an induction coil 154 with enough turns or a strong enough field to cover the entire length of the coherent mass 60 at once. Movement could be generated by, for example, a servo drive or an actuator to provide controlled relative motion.

FIG. 5 is a schematic representation of a high frequency power supply 155 connected to an induction coil 154 to cause the induction coil 154 to generate a high frequency electromagnetic field 152. As represented in FIG. 5, a high frequency electromagnetic field 152 can interact with susceptor particles 52 to induce eddy currents in the particles, thus resulting in resistive heating of the particles as described. It should be noted that FIG. 5 is provided merely to assist in explaining the mechanism of inductive heating, and is not intended to show the actual location of particles relative to the induction coil 154.

In one embodiment, as depicted in FIG. 1, the high frequency power supply 155 is paired with an impedance matching network 156 that works to maximize absorption of power output from the induction coil 154. Generally, the matching network 156 adjusts its capacitor and inductor positions to match the impedance of the induction coil 154 and power supply to that of the mixture 50 being heated to maximize the mixture 50's absorption of applied power.

In such embodiments, because the electromagnetic field generated by the induction coil 154 must penetrate the mixture 50 advancing through the interior of the mold 120, the mold 120 should be constructed of a material that does not hinder successful passage of the electromagnetic field. In other words, the mold 120 should be largely transparent to the electromagnetic field, with the exception of possible minor dielectric heating, as described above.

In addition to relative transparency to the electromagnetic field, a mold 120 material desirable for a given application may further exhibit, for example, a high dielectric strength, a high volume resistivity, a low dissipation factor at high frequencies (˜10⁶ Hz), a high continuous operating temperature, a high heat deflection temperature, and good manufacturability. These properties are considered in turn below.

First, a sufficiently high dielectric strength can reduce the tendency of the mold 120 to break down under high voltages that may be generated across it. In one embodiment, the mold 120 is constructed of a material having a dielectric strength of at least about 6 kV/mm, more preferably at least about 15 kV/mm, and even more preferably at least about 20 kV/mm.

Next, a sufficiently high volume resistivity can prevent the flow of electrical current through the material even under high voltages that may be generated across it within the mold 120. In one embodiment, the mold 120 is constructed of a material having a volume resistivity of at least about 1×10¹³ ohm·cm, more preferably at least about 1×10¹⁴ ohm·cm, and even more preferably at least about 1×10¹⁵ ohm·cm.

Next, a low dissipation factor can help prevent the mold 120 material from heating up, and thus sapping energy from the high frequency electromagnetic field 152, due to oscillating voltages applied across it. The dissipation factor—often expressed as a percentage—is a measure of the degree of loss of electric power in a dielectric material. In the context of electrical capacitors, which often contain dielectric materials, a low dissipation factor corresponds to a quality capacitor, while a high dissipation factor corresponds to a poor capacitor. In one embodiment, the mold 120 is constructed of a material having a dissipation factor of less than or equal to about 0.05 percent at 10⁶ Hz, and more preferably less than or equal to about 0.005 percent at 10⁶ Hz.

Next, high temperature resistance can help prevent the mold 120 material from yielding or otherwise deforming under high temperature conditions. Because the mold 120 may be subjected to temperature above 350 degree Fahrenheit (177 degrees Celsius), it is desirable for a mold 120 material to begin to yield or deform at substantially higher temperatures. Typical temperatures generated in the mold 120 may range from about 350 degrees Fahrenheit (about 177 degrees Celsius) to about 450 degrees Fahrenheit (about 232 degrees Celsius). Other temperature ranges are possible depending, for example, on the heat needed to raise the temperature of the given polymeric binder particles 56 above a softening point. In one embodiment, the mold 120 is constructed of a material having a continuous operating temperature and/or heat deflection temperature of at least about 450 degrees Fahrenheit (about 232 degrees Celsius), more preferably of at least about 500 degrees Fahrenheit (about 260 degrees Celsius), and even more preferably of at least about 572 degrees Fahrenheit (about 300 degrees Celsius),

Furthermore, good manufacturability can allow a mold 120 to be precision manufactured to have tightly controlled geometry and quality surfaces finishes. Typically, such features are best attained through machining processes. Therefore, it is desirable for a mold 120 material to be reasonably susceptible to machining techniques. It should also be noted that the mold 120 may be molded so long as the material employed is susceptible to molding techniques.

In consideration of some or all of the above criteria, materials that may be useful for use as a mold 120 include, but are not limited to, glass, ceramic, glass ceramic, glass filled ceramic, polytetrafluoroethylene, glass filled polytetrafluoroethylene, glass filled liquid crystal polymer, polybenzimidazole, polyaramid, polyetherimide, polyphthalamide, polyphenylene sulfide, polyetheretherketone, alumina silicate, and silicone.

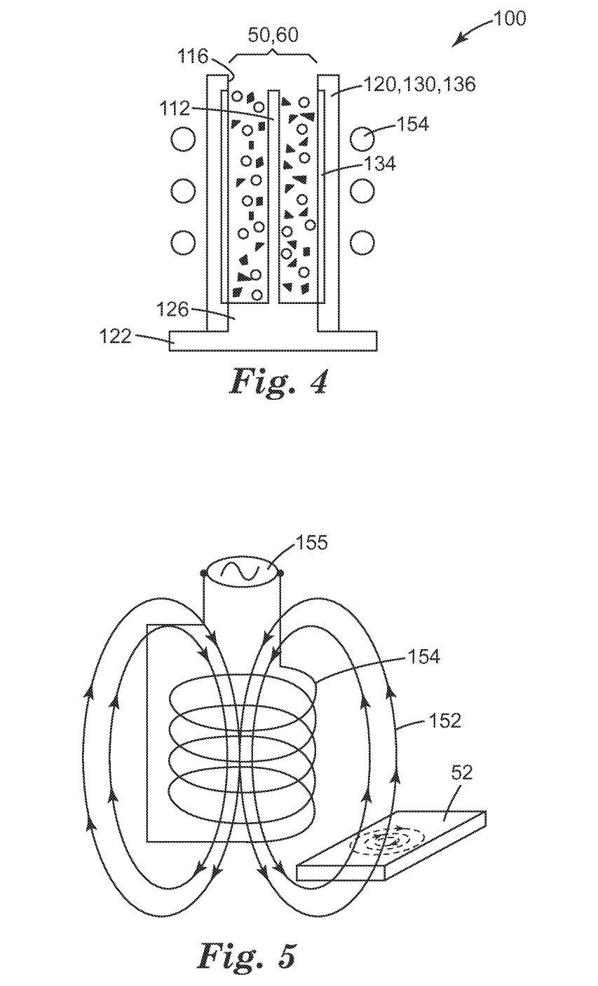

In other embodiments, such as those depicted in FIGS. 3 and 4, the mold 120 comprises a porous sleeve 130 that is releasably held by a holder 122. In such embodiments, the induction coil 154 may be disposed adjacent the holder 122 to surround at least a portion of the porous sleeve 130. The porous sleeve 130 comprises a material useful for fluid filtration. For example, the porous sleeve 130 may comprise a sintered or porous ceramic block or a sintered or porous polymer block. Where the mold 120 comprises a porous sleeve 130, some or all of the material properties discussed above as being useful for the mold 120 may be inapplicable, so long as the porous sleeve 130 is sufficiently transparent to the high frequency electromagnetic field 152.

In embodiments where the mold 120 comprises a porous sleeve 130, the mixture 50 is introduced into the porous sleeve 130 and heated as described herein such that the coherent mass 60 forms inside of, and is bound by, the porous sleeve 130. Then, the porous sleeve 130 comprising the coherent mass 60 is removable from the holder 122 such that the porous sleeve 130 becomes a portion of the filter element 80, as shown in FIG. 9. This arrangement can be advantageous as it may reduce tooling costs associated with fixed molds.

In a related embodiment, the porous sleeve 130 comprises a nonwoven sleeve 134 coaxially surrounded by an outer sleeve 136, as shown in FIGS. 4 and 9. While the outer sleeve 136 may comprise a porous block as described above, the nonwoven sleeve 134 may comprise on or more layers or combinations of materials such as an extruded mesh, a melt blown, a spun bond, a porous film, or other support or drainage layer. The nonwoven sleeve 134 can act to bind to the coherent mass 60 and also to promote fluid flow between the porous sleeve 130 and the coherent mass 60 by holding flow paths open between the two. The nonwoven sleeve 134 should also be sufficiently transparent to the high frequency electromagnetic field 152.

In some embodiments, the holder 122 comprises a mandrel 126 upon which the porous shell may be disposed and later removed, as shown in FIGS. 3 and 4. In such embodiments, the mandrel 126 can form a wall of the mold 120 to contain the mixture 50. In some embodiments, a core pin 112 extends from the mandrel 126 to form an internal profile 84 of the coherent mass 60, as shown in FIG. 4. To the extent a mandrel 126 and/or the core pin 112 may protrude into the high frequency electromagnetic field 152, it may be useful to construct one or both from a material that is sufficiently transparent to the field such as an electrical insulator.

In some embodiments, the mold 120 is effective to form a cylindrical cross section in the coherent mass 60. In some embodiments, the mold 120 is effective to form a non-cylindrical cross section in the coherent mass 60. For example, the mold 120 may be configured to form the cross section of the coherent mass 60 into an ellipse or oval. In other embodiments, the mold 120 may be configured to form the cross section of the coherent mass 60 into a rectangle, a triangle, or other polygon. Such cross sections may or may not comprise rounded edges between polygon sides. In some embodiments, a core pin 112 provides a cylindrical internal profile 84 while the mold 120 forms the external profile 82 into a non-cylindrical cross section. In some embodiments, a core pin 112 provides a non-cylindrical internal profile 84 and the mold 120 forms the external profile 82 into a non-cylindrical cross section.

In some embodiments, the susceptor particles 52 comprise adsorbent susceptor particles 52. In some embodiments, the adsorbent susceptor particles 52 comprise activated carbon. However, the susceptor particles 52 may comprise any particles that are suitable or compatible for a given end use—typically fluid purification—and are capable of being heated by internal induction of eddy currents under the influence of a high frequency electromagnetic field 152. Generally, the susceptor particles 52 will be electrical conductors or semiconductors and will not be electrical insulators. Examples of electrical conductors include, but are not limited to, silver, copper, gold, aluminum, iron, steel, brass, bronze, mercury, graphite, and the like. Examples of electrical insulators include, but are not limited to, glass, rubber, fiberglass, porcelain, ceramic, quartz, and the like. Generally, susceptor particles 52 with higher inherent electrical resistance can heat up more quickly as eddy currents flow. For example, iron can heat more quickly than copper under the influence of a high frequency electromagnetic field 152. Some, but not all, materials exhibit an increase in electrical resistance as their temperatures are elevated and thus may heat at a higher rate as their temperatures are raised in the mold 120. In some embodiments, the susceptor particles 52 have an electrical conductivity equal to or greater than about 1×10⁴ Siemens per meter at 25 degrees Celsius.

In one embodiment, the polymeric binder particles 56 comprise ultra high molecular weight polyethylene (UHMW). UHMW is well suited to the present application, for example, because of its tendency not to melt flow even at temperatures well above the softening point. Rather than melt flow, UHMW tends to merely soften and become adherent when heated above the softening point. As a result, UHMW allows the formation of a coherent mass 60 wherein individual susceptor particles 52 bind to the polymeric binder particles 56 through a form of forced point bonding or sintering. A representative example of such forced point bonding or sintering is shown in FIG. 7b, where a single susceptor particle is shown bound to a single polymeric binder particle. In such a configuration, the polymeric binder particles 56 bind the susceptor particles 52 together without melt flowing to coat the surface of the susceptor particles 52 with polymeric binder. In certain applications, particularly where the susceptor particles 52 perform an active purification function, such prevention of coating is important in order to keep active particulate surfaces available for contact with the filtrate. While UHMW is a desirable material for the polymeric binder particles 56, it should be understood that other polymers capable of being processed to cause forced point bonding as described above should also be useful.

In some embodiments, particularly where the forced point bonding or sintering result described above is not critical, other polymers may be employed as polymeric binder particles 56.

In one embodiment, the polymeric binder particles 56 are plasma treated before processing to form a coherent mass 60. Plasma treatment of the polymeric binder particles 56 can impart desirable performance characteristics to filter elements 80 formed from the coherent mass 60. For example, improved wettability and improved initial flowability may result. Moreover, it may be possible to form filter elements 80 having relatively thinner walls with the use of plasma treated polymeric binder particles 56. Other surface treatments of polymeric binder particles 56 are also envisioned, for example, grafting or surface modification to create or enhance antimicrobial properties or affinity for particular substances. Examples of such treatment of particles suitable for polymeric binder particles 56, including UHMW, is described, for example, in U.S. Pat. Pub. No. 2010/0243572 A1 to Stouffer, et al., the disclosure of which is incorporated herein by reference in its entirety. Particular benefits of such treatments are described, for example, in paragraphs [0032] through [0043] of Stouffer et al.

In some embodiments, one or more additives may accompany the mixture 50. For example, lead or arsenic reduction components, including those in particulate form, may be added to the mixture 50. In one embodiment, silver may be added to the mixture 50 to help prevent bacteria growth in the formed filter elements 80. In such embodiments, silver or other metal or highly conductive particles may be included to comprise at least a portion of the susceptor particles 52. For purposes of the present disclosure, a highly conductive susceptor particle has an electrical conductivity equal to or greater than about 0.5×10⁶ Siemens per meter at 25 degrees Celsius. Because some highly conductive materials can heat more quickly under the influence of a high frequency electromagnetic field 152, it is envisioned that the inclusion of such highly conductive susceptor particles 52 in the mixture 50 may serve to accelerate heating of the mixture 50 and therefore could be useful in providing increased heating rates. In one embodiment, highly conductive susceptor particles 52 may be combined with activated carbon susceptor particles 52 to comprise a mixture 50 that may be more quickly heated than a mixture 50 where the susceptor particles 52 comprise activated carbon alone.

Filter elements 80 formed according to the present disclosure, whether used alone or in combination with other separation devices or media, may be useful in widely varied fluid purification and separation applications, including, but not limited to, drinking water and other fluid purification, including the reduction of sediment, lead, arsenic, bacteria, viruses, chlorine, and volatile organic compounds.

It should be noted that an apparatus 100 according the present disclosure may be set up to form, among other profiles, a solid cylindrical coherent mass 60, a tubular coherent mass 60, or a blind tubular coherent mass 60. Where a tubular coherent mass 60 is desired, a core pin 112 is typically employed to assist in forming the internal profile 84 of the tubular profile. In such embodiments, the core pin 112 may extend entirely through the mold 120 or through only a portion of the mold 120. Typically, the core pin portion 112 comprises a smooth cylindrical profile, although such profile may comprise a portion that is tapered inwardly in the direction of the mold opening 116. In one such embodiment, the core pin 112 may comprise a portion that tapers inwardly at a rate of, for example, about 0.001 inches per lineal inch (0.001 mm per lineal mm) toward the opening of the mold 120. Such an inward taper of the core pin 112 can reduce frictional forces that may be encountered when removing the coherent mass 60 from the mold 120.

In some embodiments, the core pin 112 comprises a material that is transparent to the high frequency electromagnetic field 152. In such embodiments, exemplary materials for the core pin 112 may be the same or similar to those listed above for use in the mold 120. The choice of such material can be important when it is desired to prevent the core pin 112 from inductively heating under the influence of the high frequency electromagnetic field 152 and thus conductively heating the internal profile 84 of the coherent mass 60. For example, it is envisioned that provision of an electrically conductive core pin 112 in the disclosed processes could result in inductively heating the core pin 112 such that materials in the mixture 50 could be heated beyond appropriate working temperatures. Not only could such core pin 112 heating alter the formation of the coherent mass 60, but it could also result in wasted energy due to the high frequency power absorbed by the electrically conductive material rather than directly by the mixture 50 itself. However, depending on the materials employed in the mixture 50 and the desired characteristics of the filter element 80, it may be permissible or even desirable to construct the core pin 112 from a material that can heated through the induction of eddy currents.

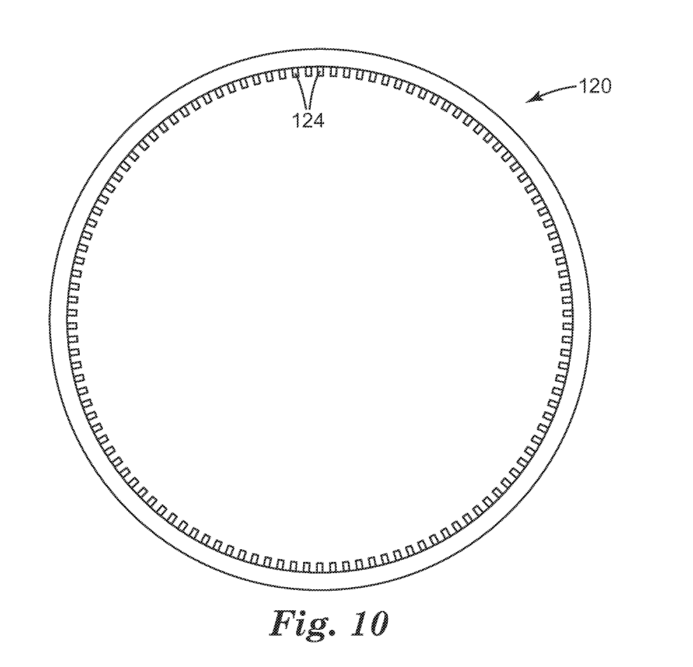

In one embodiment, as shown in FIG. 10, the mold 120 comprises a plurality of forming protrusions 124 extending inwardly from an inner surface of the mold 120 to form corresponding depressions in an outer surface of the coherent mass 60. These depressions remain after the coherent mass 60 is cooled and hardened and can increase the surface area of the outer surface of the coherent mass 60, thereby improving, for example, the sediment life of the resulting filter element 80.

Various modifications and alterations of the invention will be apparent to those skilled in the art without departing from the spirit and scope of the invention. It should be understood that the invention is not limited to illustrative embodiments set forth herein.

1. A method of forming a filter element comprising:
introducing a mixture into an apparatus comprising a mold, the mixture comprising a plurality of susceptor particles and a plurality of polymeric binder particles;
inducing eddy currents in the susceptor particles by subjecting the mixture to a high-frequency electromagnetic field, the eddy currents being sufficient to elevate the temperature of the susceptor particles to cause adjacent polymeric binder particles to be heated to at least a softening point;
binding the susceptor particles with the heated polymeric binder particles in the mold to form a coherent mass; and
cooling the coherent mass to form the filter element.

2. The method of claim 1 further comprising removing the coherent mass from the mold.

3. The method of claim 1 wherein the mold comprises a dielectric material.

4. The method of claim 1 wherein the mold comprises a porous sleeve into which the mixture is introduced such that the mold together with the coherent mass forms the filter element, the method comprising:
removing the mold from the apparatus together with the coherent mass.

5. The method of claim 4 further comprising binding the coherent mass to the porous sleeve.

6. The method of claim 4 wherein the porous sleeve comprises a nonwoven sleeve coaxially surrounded by an outer sleeve comprising one of a porous polymer or a porous ceramic.

7. The method of claim 4 further comprising:
placing the mold on a holder prior to introducing the mixture into the mold; and
removing the mold from the holder after forming the coherent mass.

8. The method of claims 7 wherein the holder comprises a core pin, the core pin forming an internal profile of the coherent mass such that the coherent mass is tubular.

9. The method of claim 8 wherein the core pin comprises a dielectric material.

10. The method of claim 1 wherein the mold comprises a core pin, the core pin forming an internal profile of the coherent mass such that at least a portion of the coherent mass is tubular.

11. The method of claim 10 wherein the core pin comprises a dielectric material.

12. The method of claim 1 wherein the high-frequency electromagnetic field oscillates in a range from about 500 kHz to about 30 MHz.

13. The method of claim 1 wherein the susceptor particles comprise activated carbon.

14. The method of claim 1 wherein the polymeric binder particles comprise ultra high molecular weight polyethylene.

15. The method of claim 1 wherein binding the susceptor particles with the heated polymeric binder particles comprises sintering the mixture such that a coherent mass is formed but polymeric binder does not coat the susceptor particles.

16. The method of claim 1 wherein the excitation portion comprises an induction coil to generate the high frequency electromagnetic field, the method comprising moving the induction coil relative to the mold to subject the entire mixture to the high frequency electromagnetic field.

17. The method of claim 16 wherein the induction coil moves and the mold is fixed.

18. The method of claim 17 wherein the mold moves and the induction coil is fixed.

19. An apparatus for forming a filter element, the apparatus comprising:
a mold; and
an induction coil surrounding at least a portion of the mold to subject a mixture within the mold to a high frequency electromagnetic field;
wherein the induction coil and the mold move with respect to one another to subject the entire mixture to the high frequency electromagnetic field.

20. The apparatus of claim 19 wherein the induction coil moves and the mold is fixed.

21. The apparatus of claim 19 wherein the mold moves and the induction coil is fixed.

22. The apparatus of claim 19 wherein the mold comprises a core pin, the core pin forming an internal profile of the filter element such that at least a portion of the filter element is tubular.

23. The apparatus of claim 22 wherein the core pin comprises a dielectric material.

24. The apparatus of claim 19 wherein the high-frequency electromagnetic field oscillates in a range from about 500 kHz to about 30 MHz.

25. An apparatus for forming a filter element, the apparatus comprising:
a holder to releasably hold a porous sleeve; and
an induction coil adjacent the holder to surround at least a portion of the porous sleeve to subject a mixture within the porous sleeve to a high frequency electromagnetic field.

26. The apparatus of claim 25 wherein the holder comprises a mandrel upon which the porous sleeve is to be disposed.

27. The apparatus of claim 25 25-26 further comprising a porous sleeve releasably held on the holder.

28. The apparatus of claim 27 wherein the porous sleeve comprises a nonwoven sleeve coaxially surrounded by an outer sleeve comprising one of a porous polymer or a porous ceramic.

29. The apparatus of claim 25 wherein the induction coil and the holder move with respect to one another to subject the entire mixture to the high frequency electromagnetic field.

30. The apparatus of claim 29 wherein the induction coil moves and the holder is fixed.

31. The apparatus of claim 29 wherein the holder moves and the induction coil is fixed.

32. The apparatus of claim 25 wherein the holder comprises a core pin, the core pin forming an internal profile of the filter element such that at least a portion of the filter element is tubular, wherein the induction coil surrounds at least a portion of the core pin.

33. The apparatus of claim 32 wherein the core pin comprises a dielectric material.

34. The apparatus of claim 25 wherein the high-frequency electromagnetic field oscillates in a range from about 500 kHz to about 30 MHz.

35. The apparatus of claim 19 wherein the mold comprises a plurality of forming protrusions extending inwardly from an inner surface of the mold.

36. The method of claim 1 further comprising forming a plurality of depressions in an external profile of the filter element.

37. A filter element formed by the method of claim 1.
